(19) United States
(12) Patent Application Publication
(10) Pub. No.: US 2003/0202674 A1
(43) Pub. Date: Oct. 30, 2003

(54) Speaker

(75) Inventor: Osamu Takahashi, Tendo (JP)

Correspondence Address: SUGHRUE MION, PLLC, 2100 PENNSYLVANIA AVENUE, N.W., WASHINGTON, DC, 20037, US

(73) Assignees: PIONEER CORPORATION; TOHOKU PIONEER CORPORATION

(21) Appl. No.: 10/410,265

(22) Filed: Apr. 10, 2003

(30) Foreign Application Priority Data
Apr. 30, 2002 (JP) 2002-129054

(51) Int. Cl. H04R 25/00; H04R 1/00; H04R 9/06; H04R 11/02

(52) U.S. Cl. 381/398; 381/189; 381/433

(57) ABSTRACT

An edge damper frame 18b is disposed in between a part of an outer peripheral surface 20a of a frame-cover 20 and a leveling surface 14c-1 of a frame 14. A slope 18e of a diaphragm 15 is extended from the edge damper frame 18b toward the frame 14 and provided alongside an outer side surface 14c-2 of a convex portion 14c of the frame 14.

### BACKGROUND OF THE INVENTION

1. Field of the Invention

This invention relates to a speaker and a diaphragm for use in speaker, and more particularly to a speaker of which peripheries of a diaphragm and a top-cover are supported by a frame and to the diaphragm for use in speaker.

2. Description of the Related Art

Heretofore, a dome speaker shown in FIGS. 2A and 2B is proposed as an example of above described speaker. FIG. 2A shows an exploded half-sectional view of the dome speaker. FIG. 2B shows a half-sectional view of the dome speaker.

As shown in FIGS. 2A and 2B, in the dome speaker, a magnetic circuit with a ring-shaped gap is composed of a disk-shaped pole-plate 10, a magnet 11 and a yoke 12. The magnetic gap 13 is a gap between a side surface of the pole-plate 10 and the yoke 12, with a substantially same interval throughout a circumference of the gap 13. Moreover, a frame 14 made of such as synthetic resin is formed integrally outside the yoke 12 composing the magnetic circuit. A frame assembly is composed of the frame 14 and the magnetic circuit.

Further, a diaphragm 15 with a substantially circle or oval shape in a plane view is disposed over the frame assembly. The diaphragm 15 includes a dome shaped vibrating portion 16, a concave portion 17 with a U-shaped section provided at an outer peripheral edge of the vibrating portion 16, an edge damper 18a provided at an outer peripheral edge of the concave portion 17, and an edge damper frame 18b provided at an outer peripheral edge of the 18a and having a surface in level to a radial direction of the 18a. The edge damper frame 18b is provided alongside a leveling surface 14b on top of the frame 14.

Moreover, the diaphragm 15 includes a rising portion 18c being provided at an outer peripheral edge of the edge damper frame 18b and rising substantially perpendicular to the outer peripheral edge integrally. The rising portion 18c is provided alongside an inner side surface 14a-1 of a convex portion 14a provided outside the leveling surface 14b of the frame 14. Furthermore, the diaphragm 15 includes a locking portion 18d being provided at a top of the rising portion 18c and having a surface in level to a radial direction of the diaphragm 15 outwardly. The locking portion 18d is provided to abut against an inner side surface 14a-2 of the convex portion 14a.

Incidentally, an edge 18 is composed of the edge damper 18a, the edge damper frame 18b, the rising portion 18c and the locking portion 18d. Moreover, the diaphragm 15 is composed of the vibrating portion 16, the concave portion 17 and the edge 18 being formed integrally by such as hot press molding a sheet of synthetic resin film.

In such structure, when the rising portion 18c is located alongside the inner side surface 14a-1 of the convex portion 14a provided on the frame 14, centers of the diaphragm 15 and the frame assembly are aligned with no misalignment, so that the diaphragm 15 is to be attached to the frame assembly in the correct position. In other words, the rising portion 18c locates a position of the diaphragm 15 corresponding to the frame 14 in radial direction.

Further, when the edge damper frame 18b is located alongside the leveling surface 14b of the frame 14, the concave portion 17 is not located outside the magnetic gap 13, so that the diaphragm 15 is to be attached to the frame assembly in the correct position. In other words, the edge damper frame 18b locates a position of the diaphragm 15 corresponding to the frame 14 in perpendicular direction.

Therefore, the concave portion 17 can be located floatingly at a correct position in the magnetic gap 13 of the magnetic circuit. A voice coil 19 made of wound electrical wire is adhered to the concave portion 17. Therefore, the voice coil 19 and the concave portion 17 are located in the magnetic gap 13 of the magnetic circuit by the edge damper 18a to be supported resiliently. Moreover, with locking portion 18d abutting against the inner side surface 14a-2 of the convex portion 14a, the diaphragm 15 is supported more firmly.

Moreover, a frame-cover 20 for protecting the diaphragm 15 is provided over the diaphragm 15. An outer peripheral surface 20a of the frame-cover 20 is located nearer to the diaphragm 15 than an inner surface 20b. Further, a locking portion 20c, falling substantially perpendicular to the outer peripheral surface 20a integrally, is provided at an outer peripheral edge of the outer peripheral surface 20a. A part of the outer peripheral surface 20a of the frame-cover 20 is supported by a leveling surface 14a-3 provided at a top of the convex portion 14a. Further, the locking portion 20c abuts against an outer side surface 14a-4 of the convex portion 14a, so that the frame-cover 20 is supported more firmly.

Incidentally, in general, the larger a vibration area of the diaphragm 15 becomes, the more advantage a speaker has when playing with sufficient sound volume in low frequency band (base range). It is because the larger the vibration area of the diaphragm is, the heavier mass of the diaphragm becomes, so that the lowest resonance frequency (fo) can be set up lower It is also because the larger the vibration area of the diaphragm becomes, the higher radiation impedance becomes and the higher sensitive sound pressures becomes.

However, in the dome speaker as described above, the leveling surface 14b for supporting the diaphragm 15 and the leveling-surface 14a-3 for supporting the frame-cover 20 are provided at different positions of the frame 14 respectively. Therefore, as shown in FIG. 2B, there is a problem that in a diameter of the whole speaker, a part S1 for supporting the diaphragm 15 and the frame-cover 20 becomes larger, a diameter S2, adding the edge damper 18a to the vibration portion 16 of the diaphragm 15 which actually vibrates, becomes smaller and resultingly the vibration area becomes smaller.

Further, in the conventional dome speaker as above described, the portion rising portion 18c stands up from the edge damper frame 18b toward the frame-cover 20. Therefore, for providing a inner side surface of the frame 14 alongside the outer side surface of the rising portion 18c, it is necessary to provide the convex portion 14a of the frame 14 outward from the outer side surface of the rising portion 18c in radial direction.

As shown in FIG. 2B, this also causes the problem that in the diameter of the whole speaker, the part S1 for supporting the diaphragm 15 and the frame-cover 20 becomes larger, the diameter S2, adding the edge damper 18a to the vibration portion 16 of the diaphragm 15 which actually vibrates, becomes smaller and resultingly the vibration area becomes smaller.

### SUMMARY OF THE INVENTION

This invention has been accomplished to solve the above described problems and an object of this invention is to provide a speaker and a diaphragm for said speaker, said speaker being enable to play in base range with a small minimum resonance frequency and have high sensitive sound pressure by enlarging a vibration area.

In order to attain the object, according to a first aspect of this invention, there is provided a speaker comprising a diaphragm; a frame-cover disposed over the diaphragm for protecting the diaphragm; and a frame placed underneath the diaphragm and the frame-cover, and having a support portion for supporting supporting points of the diaphragm and the frame-cover, said supporting point of the diaphragm being provided at an outer periphery of the diaphragm and being in level to a radial direction of the diaphragm, whereby the supporting point of the diaphragm is disposed in between the supporting point of the frame-cover and the support portion of the frame.

According to the first aspect of this invention, the supporting point of the diaphragm is disposed in between the supporting point of the frame-cover and the support portion of the frame. With such configuration, it is possible to provide a part for supporting the supporting point of the frame-cover parallel to the radial direction and a part for supporting the supporting point of the diaphragm parallel to the radial direction at a same location on the frame. Therefore, since it is not necessary to provide the parts for supporting the supporting points of the diaphragm and the frame-cover at different positions respectively, the vibration area can be provided larger.

According to a second aspect of this invention, there is provided a speaker comprising a diaphragm; a frame-cover disposed over the diaphragm for protecting the diaphragm; and a frame placed underneath the diaphragm and the frame-cover for supporting outer peripheries of the diaphragm and the frame-cover, whereby said frame includes a convex portion against the diaphragm around an outer periphery of the frame, and said diaphragm includes a slope extending from the outer periphery of the diaphragm toward the frame and having an inner side surface alongside an outer side surface of the convex portion of the frame.

According to a fourth aspect of this invention, there is provided a diaphragm comprising a slope being extended from an outer periphery of the diaphragm toward a frame for supporting the diaphragm, and includes an inner side surface alongside an outer side surface of a convex portion of the frame, said convex portion being provided around an outer periphery of the frame against the diaphragm.

According to the second and fourth aspects of this invention, the slope of the diaphragm extends from its outer periphery toward the frame and includes the inner side surface alongside the outer side surface of the convex portion provided at the outer periphery of the frame. With such configuration, it is not necessary for the frame to extend outward from the outer side surface of the slope in radial direction. Thus, the vibration area can be provided larger.

According to a third aspect of this invention, there is provided a speaker comprising: a diaphragm; a frame-cover disposed over the diaphragm for protecting the diaphragm; and a frame placed underneath the diaphragm and the frame-cover, and having a support portion for supporting supporting points of the diaphragm and the frame-cover, said supporting point of the diaphragm being provided at an outer periphery of the diaphragm and being in level to a radial direction of the diaphragm, whereby said frame includes a convex portion against the diaphragm around an outer periphery of the frame, said diaphragm includes a slope extending from the outer periphery of the diaphragm toward the frame and having an inner side surface alongside an outer side surface of the convex portion of the frame, the support portion of the frame is provided at a top of the convex portion, and the supporting point of the diaphragm is disposed in between the supporting point of the frame-cover and the support portion of the frame.

According to the third aspect of this invention, the supporting point of the diaphragm is disposed in between the supporting point of the frame-cover and the supporting portion provided at the top of the convex portion of the frame. With such configuration, it is possible to provide a part for supporting the supporting point of the frame-cover parallel to the radial direction and a part for supporting the supporting point of the diaphragm parallel to the radial direction at a same location on the frame. Therefore, since it is not necessary to provide the parts for supporting the supporting points of the diaphragm and the frame-cover at different positions respectively, the vibration area can be provided larger.

Further, the slope of the diaphragm extends from its outer periphery toward the frame and includes the inner side surface alongside the outer side surface of the convex portion of the frame. With such configuration, it is not necessary for the frame to extend outward from the outer side surface of the slope in radial direction. Thus, the vibration area can be provided larger.

### BRIEF DESCRIPTION OF THE DRAWINGS

FIG. 1A is an exploded half-sectional view showing one embodiment of a speaker in which a diaphragm is embedded according to this invention;

FIG. 1B is a half-sectional view of the speaker in FIG. 1;

FIG. 2A is an exploded half-sectional view of one example of the conventional dome speaker; and

FIG. 2B is a half-sectional view of the example of the conventional dome speaker.

### DESCRIPTION OF THE PREFERRED EMBODIMENT

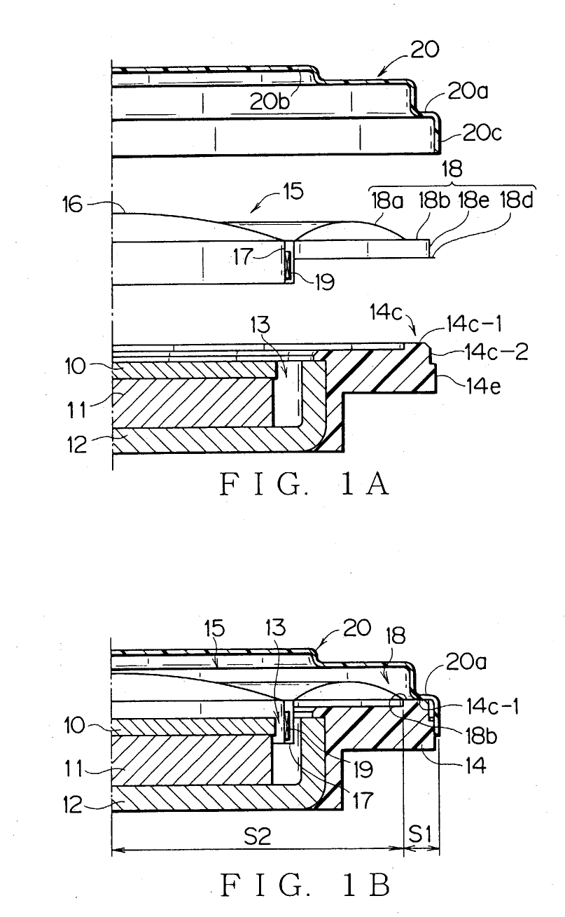

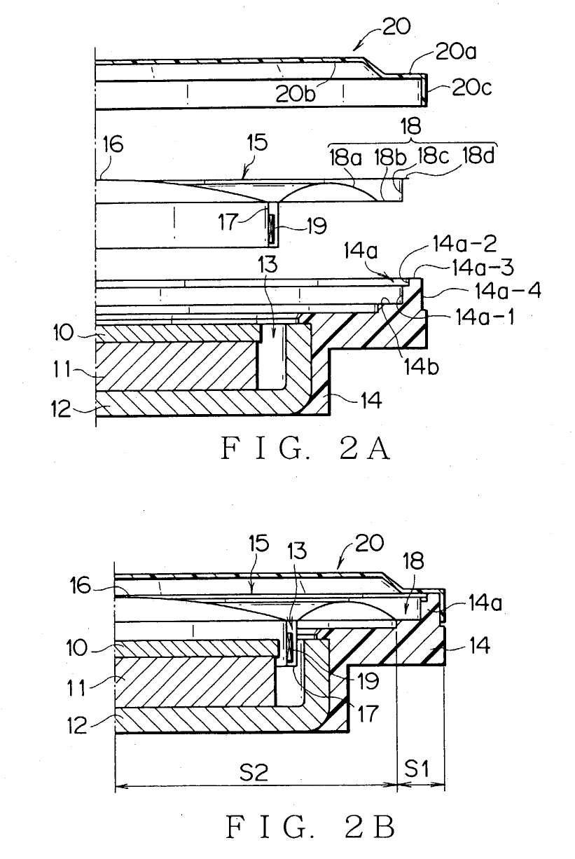

One embodiment of this invention will now be described with reference to the attached drawings. Each of FIGS. 1A and 1B is a view showing one embodiment of a speaker in which a diaphragm is embedded according to this invention. FIG. 1A shows an exploded half-sectional view of the speaker. FIG. 2B shows a half-sectional view of the speaker. In these figures, parts equivalent to the parts in FIGS. 2A and 2B are denoted by the same reference numerals so as to omit detailed explanations.

A difference in between the speaker of this invention and a conventional speaker as shown in FIGS. 2A and 2B is a shape of the frame 14. Heretofore, the frame 14 has the convex portion 14a (FIGS. 2A and 2B) located outward from the diaphragm 15. However, the frame 14 of this invention has a convex portion 14c located inward from the diaphragm 15. A leveling surface 14c-1 for supporting the edge damper frame 18b is provided at the top of the convex portion 14c.

Further, a shape of the edge 18 of the diaphragm 15 is also different from the conventional one. Heretofore, the edge 18 has the rising portion 18c which stands up substantially perpendicular to the frame-cover 20 from the outer peripheral edge of the edge damper frame 18b. However, the edge 18 of this invention has a slope 18e which sits down substantially perpendicular to the frame 14 from the outer peripheral edge of the edge damper frame 18b. This slope 18e is provided alongside an outer side surface 14c-2 of the convex portion 14c. A shape of the diaphragm 15 is a substantial circle or oval in plane view.

Further, a locking portion 18d is provided at a bottom edge of the slope 18e. This locking portion 18d is provided so as to abut against the inner side surface of the locking portion 20c of the frame-cover 20.

In such structure, when the slope 18e is located alongside the outer side surface 14c-2 of the convex portion 14c provided on the frame 14, centers of the diaphragm 15 and the frame assembly are aligned with no misalignment, so that the diaphragm 15 is to be attached to the frame assembly in the correct position.

Further, when the edge damper frame 18b is located alongside the leveling surface 14c-1 provided at the top of the convex portion 14c, the concave portion 17 is not located outside the magnetic gap 13, so that the diaphragm 15 is to be attached to the frame assembly in the correct position. In other words, the edge damper frame 18b locates a position of the diaphragm 15 corresponding to the frame 14 in perpendicular direction. Moreover, with the locking portion 18d abutting against the inner side surface of the locking portion 20c of the frame-cover 20, the diaphragm 15 is supported more firmly.

Another difference in between the speaker of this invention and a conventional speaker as shown in FIGS. 2A and 2B is a shape of the frame-cover 20. The outer peripheral surface 20a of the frame-cover 20 is located nearer by two steps than the inner surface 20b of the frame-cover 20. Moreover, in a same manner as the conventional speaker, the locking portion 20c, falling substantially perpendicular to the outer peripheral surface 20a integrally, is.provided at an outer peripheral edge of the outer peripheral surface 20a.

Further, the edge damper frame 18b is disposed in between the part of the outer peripheral surface 20a of the frame-cover 20 and the leveling surface 14c-1 of the frame 14 (FIG. 1B). Therefore, the leveling surface 14c-1 supports both the edge damper frame 18b and the outer peripheral surface 20a. Moreover, with the locking portion 20c abutting against an outer side surface 14e, the frame-cover 20 is supported more firmly.

With such configuration, it is possible to provide a part for supporting the outer peripheral surface 20a as the supporting point of the frame-cover 20 and a part for supporting the edge damper frame 18b as the supporting point of the diaphragm 15 are provided at a same location (leveling surface 14c-1) on the frame 14. Therefore, it is not necessary to provide the part for supporting the edge damper frame 18b of the diaphragm 15 and the part for supporting the outer peripheral surface 20a of the frame-cover 20 at different positions respectively on the frame 14.

Moreover, according to the speaker of this invention, the slope 18e of the diaphragm 15 is extended from the edge damper frame 18b toward the frame 14 and provided alongside the outer side surface 14c-2 of the convex portion 14c of the frame 14. With such configuration, it is not necessary to extend outward from the outer side surface of the slope 18e.

Therefore, in the diameter of the whole speaker, the part S1 for supporting the diaphragm 15 and the frame-cover 20 can be larger. And the diameter S2, adding the edge damper 18a to the vibration portion 16 of the diaphragm 15 which actually vibrates, can be smaller. Namely, the vibration area can be larger. Therefore, the minimum resonance frequency is to be smaller, so that the speaker can play in base range and have high sensitive sound pressure.

Incidentally, the contents of Japanese Patent Application No. 2002-129054 are hereby incorporated by reference.

Although this invention has been fully described by way of examples with reference to the accompanying drawings, it is to be noted that various changes and modifications can be made in a scope of this invention.

What is claimed is:

1. A speaker comprising:
a diaphragm;
a frame-cover disposed over the diaphragm for protecting the diaphragm; and
a frame placed underneath the diaphragm and the frame-cover, and having a support portion for supporting supporting points of the diaphragm and the frame-cover, said supporting point of the diaphragm being provided at an outer periphery of the diaphragm and being in level to a radial direction of the diaphragm,
whereby the supporting point of the diaphragm is disposed in between the supporting point of the frame-cover and the support portion of the frame.

2. A speaker-comprising:
a diaphragm;
a frame-cover disposed over the diaphragm for protecting the diaphragm; and
a frame placed underneath the diaphragm and the frame-cover for supporting outer peripheries of the diaphragm and the frame-cover,
whereby said frame includes a convex portion against the diaphragm around an outer periphery of the frame, and said diaphragm includes a slope extending from the outer periphery of the diaphragm toward the frame and having an inner side surface alongside an outer side surface of the convex portion of the frame.

3. A speaker comprising:
a diaphragm;
a frame-cover disposed over the diaphragm for protecting the diaphragm; and
a frame placed underneath the diaphragm and the frame-cover, and having a support portion for supporting supporting points of the diaphragm the frame-cover, said supporting point of the diaphragm being provided at an outer periphery of the diaphragm and being in level to a radial direction of the diaphragm,
whereby said frame includes a convex portion against the diaphragm around an outer periphery of the frame, said diaphragm includes a slope extending from the outer periphery of the diaphragm toward the frame and having an inner side surface alongside an outer side surface of the convex portion of the frame, the support portion of the frame is provided at a top of the convex portion, and the supporting point of the diaphragm is disposed in between the supporting point of the frame-cover and the support portion of the frame.

4. A diaphragm comprising a slope being extended from an outer periphery of the diaphragm toward a frame for supporting the diaphragm, and including an inner side surface alongside an outer side surface of a convex portion of the frame, said convex portion being provided around an outer periphery of the frame against the diaphragm.
